(19) United States
(12) Patent Application Publication
(10) Pub. No.: US 2015/0194235 A1
(43) Pub. Date: Jul. 9, 2015

(54) METHOD OF MANUFACTURING CONDUCTIVE FILM AND COMPOSITION FOR FORMING CONDUCTIVE FILM

(71) Applicant: FUJIFILM Corporation, Tokyo (JP)

(72) Inventors: Toshihiro KARIYA, Ashigara-kami-gun (JP); Hiroshi OHTA, Ashigara-kami-gun (JP)

(73) Assignee: FUJIFILM CORPORATION, Tokyo (JP)

(21) Appl. No.: 14/665,435

(22) Filed: Mar. 23, 2015

Related U.S. Application Data
(63) Continuation of application No. PCT/JP2013/073772, filed on Sep. 4, 2013.

(30) Foreign Application Priority Data
Sep. 26, 2012 (JP) 2012-212631

(51) Int. Cl. H01B 1/22; H01B 13/00

(52) U.S. Cl. CPC H01B 1/22; H01B 13/003

(57) ABSTRACT

A conductive film manufacturing method includes a coating formation step of forming a coating by applying onto a thermoplastic resin substrate a conductive film-forming composition including copper oxide particles (A), copper particles (B), and an organic polymer (C), a ratio of a copper particle (B) content to a copper oxide particle (A) content as expressed by B/A being 10 to 50 wt %, and a reduction step of reducing the copper oxide particles (A) through irradiation of the coating with pulsed light, thereby forming a copper-containing conductive film. The conductive film obtained by irradiation with pulsed light according to this method has good adhesion to the thermoplastic resin substrate.

### CROSS-REFERENCE TO RELATED APPLICATIONS

This application is a Continuation of PCT International Application No. PCT/JP2013/073772 filed on Sep. 4, 2013, which claims priority under 35 U.S.C. §119(a) to Japanese Application No. 2012-212631 filed on Sep. 26, 2012 Each of the above application(s) is hereby expressly incorporated by reference, in its entirety, into the present application.

### BACKGROUND OF THE INVENTION

The present invention relates to a method of manufacturing a conductive film and a composition for forming the conductive film.

A method of forming a conductive film for interconnects and the like is known which involves applying a dispersion of metal particles or metal oxide particles onto a substrate by a printing process and sintering the applied dispersion by heating treatment.

This method is simple, energy-saving and resource-saving as compared to conventional methods for forming a conductive film using a high-temperature vacuum process (sputtering) or plating. Accordingly high expectations are placed on this method in the development of next generation electronics. In particular, a conductive film-forming method which involves the use of a composition containing metal oxide particles and includes reducing and sintering the composition through heating treatment has attracted attention in recent years in terms of cost reduction.

On the other hand, when sintering is performed by heating treatment as described above, the substrate is exposed to high temperatures. Therefore, there arises a problem that when the substrate used is made of a thermoplastic resin such as polyethylene terephthalate (PET), it is difficult to obtain a uniform conductive film because of melting of the substrate.

Under the circumstances, JP 2010-528428 A discloses a metallic copper film formation method which involves the use of pulsed light in sintering so that copper oxide ink on a thermoplastic resin substrate such as a PET substrate is sintered without excessively heating the substrate (e.g., paragraph [0013] and Example 1).

### SUMMARY OF THE INVENTION

By reference to JP 2010-528428 A, the inventors of the present invention applied a composition containing copper oxide particles onto a thermoplastic resin substrate such as a PET substrate to form a coating and irradiated the thus formed coating with pulsed light to form a conductive film. However, it was clarified that the adhesion between the substrate and the conductive film was not sufficient. Such insufficient adhesion between the substrate and the conductive film is a problem because disconnection, short circuit and other defects are more likely to occur upon formation of interconnects and the like.

An object of the present invention is to provide a conductive film manufacturing method with which a conductive film having good adhesion to a thermoplastic resin substrate is obtained by irradiation with pulsed light.

The inventors of the present invention have made an intensive study to solve the foregoing problem and as a result found that the adhesion between a thermoplastic resin substrate and a conductive film is improved by using a composition for forming the conductive film which contains copper particles in a predetermined amount with respect to copper oxide particles, and the present invention has been thus completed. More specifically, the inventors of the present invention have found that the above-described problem can be solved by the characteristic features as described below.

(1) A conductive film manufacturing method comprising: a coating formation step of forming a coating by applying onto a thermoplastic resin substrate a conductive film-forming composition comprising copper oxide particles (A); copper particles (B); and an organic polymer (C), a ratio of a copper particle (B) content to a copper oxide particle (A) content as expressed by B/A being 10 to 50 wt %; and a reduction step of reducing the copper oxide particles (A) through irradiation of the coating with pulsed light, thereby forming a copper-containing conductive film.

(2) The conductive film manufacturing method according to (1), wherein the ratio as expressed by B/A is 15 to 40 wt %.

(3) The conductive film manufacturing method according to (1) or (2), wherein the copper particles (B) are contained in an amount of 10 to 20 wt % with respect to a total amount of the conductive film-forming composition.

(4) The conductive film manufacturing method according to any of (1) to (3), wherein the copper oxide particles (A) are contained in an amount of 40 to 60 wt % with respect to a total amount of the conductive film-forming composition.

(5) The conductive film manufacturing method according to any of (1) to (4), wherein a ratio of an organic polymer (C) content to the copper oxide particle (A) content as expressed by C/A is 10 to 30 wt %.

(6) The conductive film manufacturing method according to any of (1) to (5), wherein the copper particles (B) have an average particle size of 50 to 500 nm.

(7) The conductive film manufacturing method according to any of (1) to (6), wherein the organic polymer (C) has a weight-average molecular weight of 100,000 or more.

(8) The conductive film manufacturing method according to any of (1) to (7), wherein a thermoplastic resin making up the thermoplastic resin substrate has a glass transition temperature of 160° C. or less.

(9) The conductive film manufacturing method according to any of (1) to (8), wherein the organic polymer (C) is at least one polymer selected from the group consisting of polyvinylpyrrolidone, polyvinyl alcohol and polyethylene glycol.

(10) The conductive film manufacturing method according to any of (1) to (9), wherein the copper oxide particles (A) are copper(II) oxide particles.

(11) The conductive film manufacturing method according to any of (1) to (10), wherein the conductive film-forming composition further comprises water or a water-soluble alcohol as a main solvent.

(12) The conductive film manufacturing method according to any of (1) to (11), wherein the thermoplastic resin substrate is a polyethylene terephthalate substrate.

(13) The conductive film manufacturing method according to any of (1) to (12), wherein the copper particles (B) are polymer-coated copper particles.

(14) The conductive film manufacturing method according to any of (1) to (13), further comprising a drying step of drying the coating prior to the reduction step.

(15) A conductive film-forming composition comprising: copper oxide particles (A); copper particles (B); and an organic polymer (C), wherein a ratio of a copper particle (B) content to a copper oxide particle (A) content as expressed by B/A is 10 to 50 wt %.

(16) The conductive film-forming composition according to (15), wherein the ratio as expressed by B/A is 15 to 40 wt %.

As will be described later, the present invention can provide a conductive film manufacturing method with which a conductive film having good adhesion to a thermoplastic resin substrate is obtained by irradiation with pulsed light.

### DETAILED DESCRIPTION OF THE INVENTION

The conductive film manufacturing method according to the invention is described below.

A characteristic feature of the invention compared to the conventional art is first described in detail.

The characteristic feature of the conductive film manufacturing method according to the invention is the use of a conductive film-forming composition which contains copper particles in a predetermined amount with respect to copper oxide particles.

In a case where a coating of copper oxide ink is irradiated with pulsed light as in the method described in JP 2010-528428 A, the surface layer of the coating absorbs energy to cause reduction and sintering (hereinafter referred to also as “reductive sintering”) of copper oxide but most of the absorbed energy remains in the surface layer because of low thermal conductivity of the copper oxide and reductive sintering does not sufficiently proceed in the region below the surface layer. As a result, the adhesion between the resulting conductive film and the substrate is not sufficient.

In contrast, according to the invention, the conductive film-forming composition contains a predetermined amount of copper particles in addition to copper oxide particles and hence in a case where a coating is irradiated with pulsed light, energy absorbed in the surface layer of the coating is converted to thermal energy, which is conducted in the region below the surface layer by the medium of the copper particles having high thermal conductivity, whereupon reductive sintering proceeds over the whole of the coating to form a conductive film. The thermal energy reaches and softens a thermoplastic resin substrate and the conductive film and the substrate are therefore fusion bonded to each other. As a result, the conductive film obtained has good adhesion to the substrate.

On the other hand, in a case where the copper particle content is lower than the predetermined amount (in a case where the ratio of the copper particle content to the copper oxide particle content is less than 10 wt %), the thermal conductivity of the coating is insufficient and reductive sintering in the whole of the coating does not proceed sufficiently. In addition, the substrate hardly softens because the amount of thermal energy that may reach the substrate is small. As a result, the adhesion between the resulting conductive film and the substrate is not sufficient.

In a case where the copper particle content is higher than the predetermined amount (in a case where the ratio of the copper particle content to the copper oxide particle content exceeds 50 wt %), the thermal conductivity of the coating is increased more than necessary so that an excessive amount of thermal energy reaches and melts the thermoplastic resin substrate to cause the substrate and the conductive film to be distorted. As a result, the adhesion between the resulting conductive film and the substrate is not sufficient.

The conductive film manufacturing method according to the invention includes the following two steps:
(1) A coating formation step of forming a coating by applying onto a thermoplastic resin substrate a conductive film-forming composition including copper oxide particles (A); copper particles (B); and an organic polymer (C), a ratio of a copper particle (B) content to a copper oxide particle (A) content as expressed by B/A being 10 to 50 wt %; and
(2) a reduction step of reducing the copper oxide particles (A) through irradiation of the coating with pulsed light, thereby forming a copper-containing conductive film.

As will be described later, the conductive film manufacturing method of the invention preferably further includes a drying step of drying the coating prior to the step (2) because of more excellent adhesion between the substrate and the conductive film and excellent electrical conductivity of the conductive film.

Each step is described in detail below.

[Step (1): Coating Formation Step]

Step (1) is a step of forming a coating by applying onto a thermoplastic resin substrate a conductive film-forming composition including copper oxide particles (A); copper particles (B); and an organic polymer (C), the ratio of the copper particle (B) content to the copper oxide particle (A) content as expressed by B/A being 10 to 50 wt %.

The materials (thermoplastic resin substrate, conductive film-forming composition) that may be used in this step are first described in detail and the procedure of the step is then described in detail.

<Thermoplastic Resin Substrate>

According to the invention, a thermoplastic resin substrate is used as the substrate.

As described above, the thermoplastic resin substrate is used in the invention as the substrate, so that the substrate softens to be fusion bonded to the conductive film in the step (2) to be described later, thus improving the adhesion.

The thermoplastic resin substrate for use in the invention is not particularly limited as long as it is composed of a thermoplastic resin.

Examples of the thermoplastic resin making up the thermoplastic resin substrate include polyolefin resins such as polyethylene, polypropylene and polybutylene; methacrylic resins such as polymethyl methacrylate; polystyrene resins such as polystyrene, ABS and AS; polyester resins such as polyethylene terephthalate (PET), polybutylene terephthalate (PBT), polytrimethylene terephthalate, polyethylene naphthalate (PEN), and poly(1,4-cyclohexyldimethylene terephthalate) (PCT); polyamide resins selected from among nylon resins and nylon copolymer resins such as polycaproamide (nylon 6), polyhexamethylene adipamide (nylon 66), polyhexamethylene sebacamide (nylon 610), polyhexamethylene dodecanamide (nylon 612), polydodecanamide (nylon 12), polyhexamethylene terephthalamide (nylon 6T), polyhexamethylene isophthalamide (nylon 6I), polycaproamide/polyhexamethylene terephthalamide copolymer (nylon 6/6T), polyhexamethylene adipamide/polyhexamethylene terephthalamide copolymer (nylon 66/6T), polyhexamethylene adipamide/polyhexamethylene isophthalamide copolymer (nylon 66/6I); polyvinyl chloride resins; polyoxymethylene (POM); polycarbonate (PC) resins; polyphenylene sulfide (PPS) resins; modified polyphenylene ether (PPE) resins; polyetherimide (PEI) resins; polysulfone (PSF) resins; polyethersulfone (PES) resins; polyketone resins; polyether nitrile (PEN) resins; polyether ketone (PEK) resins; polyether ether ketone (PEEK) resins; polyether ketone ketone (PEKK) resins; polyimide (PI) resins; polyamide-imide (PAI) resins; fluororesins; modified resins obtained by modifying these resins or mixtures of these resins.

Among these, polyester resins or polycarbonate resins are preferable, polyester resins are more preferable, PET or PEN (polyethylene naphthalate) is even more preferable and PET is particularly preferable because of more excellent adhesion between the substrate and the conductive film and excellent electrical conductivity of the conductive film.

The glass transition temperature (Tg) of the thermoplastic resin making up the thermoplastic resin substrate is not particularly limited and is preferably up to 160° C., more preferably up to 130° C. and even more preferably up to 100° C. because of more excellent adhesion between the substrate and the conductive film and excellent electrical conductivity of the conductive film. The lower limit of the glass transition temperature is also not particularly limited and is preferably 50° C. or more.

The glass transition temperature as used herein refers to a glass transition temperature as measured by DSC (differential scanning calorimetry).

The thermoplastic resin substrate preferably has a thickness of 1 to 500 μm and more preferably 10 to 150 μm in terms of handleability.

<Conductive Film-Forming Composition>

The conductive film-forming composition for use in the invention (hereinafter referred to also as “conductive film-forming composition of the invention) includes copper oxide particles (A), copper particles (B) and an organic polymer (C) and the ratio of the copper particle (B) content to the copper oxide particle (A) content as expressed by B/A is 10 to 50 wt %.

The conductive film-forming composition of the invention preferably contains a solvent (D) in terms of printing performance.

The respective ingredients (copper oxide particles (A), copper particles (B), organic polymer (C), solvent (D) and the like) of the conductive film-forming composition are described below in detail.

(Copper Oxide Particles (A))

The copper oxide particles (A) contained in the conductive film-forming composition are not particularly limited if they are composed of particulate copper oxide.

The term “particulate” refers to a small particle shape, specific examples thereof including a spherical shape and an ellipsoidal shape. The copper oxide particles may not be in a complete spherical or ellipsoidal shape but be partially deformed.

The “copper oxide” as used in the invention refers to a compound substantially free from unoxidized copper. The term “substantially free from copper” refers, but is not limited, to a copper content of up to 1 wt % with respect to the copper oxide particles. The copper content with respect to the copper oxide particles is measured by XRD (X-ray diffractometry).

The copper oxide particles (A) are preferably copper(I) oxide particles or copper(II) oxide particles, and more preferably copper(II) oxide particles because they are available at low cost and the resulting conductive film has good electrical conductivity.

The average particle size of the copper oxide particles (A) is not particularly limited and is preferably up to 200 nm and more preferably up to 100 nm. The lower limit is also not particularly limited and is preferably 1 nm or more.

It is preferable for the average particle size to be 1 nm or more because the particles have moderate activity at their surfaces, do not dissolve in the composition and are excellent in handleability. It is also preferable for the average particle size to be up to 200 nm because patterning is easily made for interconnects and the like by a printing process using the composition as the ink composition for inkjet printing, the copper oxide is sufficiently reduced to metallic copper when the composition is formed into a conductor, and the resulting conductive film has good electrical conductivity. The “average particle size” as used in the invention refers to an average primary particle size. The average particle size is determined by measuring the particle size (diameter) of at least 50 copper oxide particles through observation using a transmission electron microscope (TEM) and calculating the arithmetic mean of the measurements. If a copper oxide particle does not have a perfect circle shape in an observed image, the major axis is measured as the diameter.

Exemplary copper oxide particles that may be preferably used include CuO nanoparticles manufactured by Kanto Chemical Co., Inc. and CuO nanoparticles manufactured by Sigma-Aldrich.

The copper oxide particle (A) content with respect to the total amount of the conductive film-forming composition is preferably 20 to 80 wt %, more preferably 30 to 70 wt % and even more preferably 40 to 60 wt % because of more excellent adhesion between the substrate and the conductive film and excellent electrical conductivity of the conductive film.

(Copper Particles (B))

The copper particles (B) contained in the conductive film-forming composition are not particularly limited if they are composed of particulate copper.

The term “particulate” has the same definition as in the above-described copper oxide particles (A).

The “copper” as used in the invention refers to a compound substantially free from copper oxide. The term “substantially free from copper oxide” refers, but is not limited, to a copper oxide content of up to 1 wt % with respect to the copper particles. The copper oxide content with respect to the copper particles is measured by XRD.

The average particle size of the copper particles (B) is not particularly limited and is preferably 30 to 3,000 nm, more preferably 50 to 500 nm, even more preferably 50 to 250 nm, still even more preferably 100 to 250 nm and most preferably 100 to 200 nm because of more excellent adhesion between the substrate and the conductive film and excellent electrical conductivity of the conductive film.

The term “average particle size” has the same definition as in the above-described copper oxide particles (A).

The copper particles (B) are preferably polymer-coated copper particles (copper particles coated with a polymer) because of more excellent adhesion between the substrate and the conductive film and excellent electrical conductivity of the conductive film. The polymer-coated copper particles as used herein may be copper particles partially or entirely coated with a polymer, and are preferably copper particles entirely coated with a polymer.

The polymer is preferably polyvinylpyrrolidone, polyvinyl alcohol, polyethylene glycol, gelatin, collagen or polyacrylic acid, and more preferably gelatin (particularly decomposed by an enzyme). The gelatin preferably has a weight-average molecular weight of up to 10,000. The weight-average molecular weight is a polystyrene-equivalent value obtained by gel permeation chromatography (GPC) (solvent: N-methylpyrrolidone).

The copper particle (B) content with respect to the total amount of the conductive film-forming composition is preferably 3 to 30 wt %, more preferably 7 to 23 wt % and even more preferably 10 to 20 wt % because of more excellent adhesion between the substrate and the conductive film.

In the conductive film-forming composition of the invention, the ratio of the copper particle (B) content to the copper oxide particle (A) content as expressed by B/A is 10 to 50 wt %.

As described above, the present invention uses the conductive film-forming composition including the copper particles (B) in the predetermined amount with respect to the copper oxide particles (A) and hence the resulting conductive film has good adhesion to the substrate.

The ratio B/A is preferably 15 to 40 wt % and more preferably 20 to 30 wt % because of more excellent adhesion between the substrate and the conductive film and excellent electrical conductivity of the conductive film.

(Organic Polymer (C))

The organic polymer (C) serves as a binder of the copper oxide particles (A) and the copper particles (B) and imparts the toughness to the conductive film.

Examples of the organic polymer (C) contained in the conductive film-forming composition include acrylic polymers (e.g., polymers or copolymers of acrylic monomers such as (meth)acrylic acid ester, (meth)acrylic acid, (meth)acrylamide, and (meth) acrylonitrile), polyvinylpyrrolidone, polyvinyl alcohol, polyvinyl acetal, polyethylene glycol, polyester, polyamide, polyimide and polyurethane. Among these, polyvinylpyrrolidone, polyvinyl alcohol or polyethylene glycol is preferable and polyvinylpyrrolidone is more preferable because of more excellent adhesion between the substrate and the conductive film and further improved toughness of the conductive film.

The weight-average molecular weight of the organic polymer (C) is not particularly limited and is preferably 1,000 to 1,000,000 and more preferably 100,000 to 300,000 because of more excellent adhesion between the substrate and the conductive film and excellent electrical conductivity of the conductive film.

The weight-average molecular weight is a polystyrene-equivalent value obtained by GPC (solvent: N-methylpyrrolidone).

The organic polymer (C) content with respect to the total amount of the conductive film-forming composition is preferably 1 to 30 wt %, and more preferably 5 to 15 wt % because of more excellent adhesion between the substrate and the conductive film.

The ratio of the organic polymer (C) content to the copper oxide particle (A) content as expressed by C/A is preferably 5 to 50 wt % and more preferably 10 to 30 wt % because of more excellent adhesion between the substrate and the conductive film and excellent electrical conductivity of the conductive film.

(Solvent (D))

The conductive film-forming composition of the invention preferably contains a solvent (D) in terms of printing performance. The solvent (D) serves as the dispersion medium of the copper oxide particles (A) and the copper particles (B).

The solvent (D) is not particularly limited, and water and organic solvents such as alcohols (in particular water-soluble alcohols), ethers and esters can be used. Among these, water or a water-soluble alcohol is preferably used as the main solvent. The “main solvent” as used herein refers to a solvent contained in the largest amount among the solvents used. Examples of the water-soluble alcohol include mono- to trihydric aliphatic alcohols (e.g., glycerol).

The solvent (D) content is not particularly limited and is preferably 5 to 50 wt % and more preferably 8 to 40 wt % with respect to the total weight of the composition from the viewpoints that an increase in viscosity is suppressed and that the handleability is excellent.

(Other Ingredients)

The conductive film-forming composition of the invention may contain ingredients other than the respective ingredients described above.

For example, the conductive film-forming composition of the invention may contain a surfactant. The type of the surfactant is not particularly limited, examples thereof including anionic surfactants, cationic surfactants, nonionic surfactants, fluorosurfactants and ampholytic surfactants. These surfactants may be used alone or as a mixture of two or more thereof.

(Viscosity of Conductive Film-Forming Composition)

The viscosity of the conductive film-forming composition of the invention is preferably adjusted to a value suitable for use in printing such as inkjet printing or screen printing. When inkjet discharge is performed, the viscosity is preferably 1 to 50 cP and more preferably 1 to 40 cP. In the case of screen printing, the viscosity is preferably 1,000 to 100,000 cP and more preferably 10,000 to 80,000 cP.

(Method of Preparing Conductive Film-Forming Composition)

The method of preparing the conductive film-forming composition of the invention is not particularly limited and any known method may be employed. For example, the composition can be obtained by adding the copper oxide particles (A), the copper particles (B) and the organic polymer (C) to the solvent (D) and dispersing the ingredients by known means including an ultrasonic technique (for example, treatment with an ultrasonic homogenizer), mixing, three roll milling and ball milling.

<Procedure of Step (1)>

Step (1) is a step in which the above-described conductive film-forming composition is applied onto a thermoplastic resin substrate to form a coating.

The method of applying the conductive film-forming composition onto the thermoplastic resin substrate is not particularly limited and any known method may be employed. Examples of the method include a screen printing process, a dip coating process, a spray coating process, a spin coating process, an inkjet process and other coating processes. Among these, a screen printing process and an inkjet process are preferable because they are simple and allow easy manufacture of a large-sized conductive film.

The coating is not particularly limited in shape and may be in a planar shape covering the entire surface of the substrate or in a pattern shape (e.g., in the shape of interconnects or dots).

The amount of the conductive film-forming composition applied onto the substrate may be appropriately adjusted according to the desired thickness of the conductive film. In general, the coating has a thickness of preferably 0.01 to 5,000 μm and more preferably 0.1 to 1,000 μm.

[Drying Step]

The conductive film manufacturing method of the invention preferably further includes a drying step of drying the coating formed in Step (1) prior to Step (2) because of more excellent adhesion between the substrate and the conductive film and excellent electrical conductivity of the conductive film.

The drying step allows removal of the solvent remaining in the coating and the reduction step to be described later allows reduction of fine cracks and voids that may occur due to expansion of the solvent upon vaporization.

A hot air dryer or the like may be used as the drying method.

The drying temperature is preferably such a temperature that reduction of the oxide particles (A) does not occur. To be more specific, the temperature is preferably 40 to 200° C., more preferably 45 to 150° C. and even more preferably 50 to 120° C.

The drying time is not particularly limited and is preferably 1 to 60 minutes because of more excellent adhesion between the substrate and the conductive film and excellent electrical conductivity of the conductive film.

[Step (2): Reduction Step]

Reduction step (2) is a step of reducing the copper oxide particles (A) through irradiation of the coating formed in Step (1) (the coating after drying if the drying step is included) with pulsed light, thereby forming a copper-containing conductive film.

Pulsed light irradiation treatment is a treatment in which the coating is irradiated with pulsed light for a short period of time and does not excessively heat the substrate. Therefore, the thermoplastic resin substrate can be used as the substrate.

As described above, in a case where the coating is irradiated with pulsed light, reductive sintering proceeds in the surface layer of the coating and energy absorbed in the surface layer is conducted to the region below the surface layer by the medium of the copper particles (B) in the coating, whereby reductive sintering proceeds over the whole of the coating. More specifically, copper particles generated by reduction of the copper oxide particles (A) and the copper particles (B) are fusion bonded to each other to form grains, which are further adhered and fusion bonded to each other to form a copper-containing conductive film.

The light source that may be used in the pulsed light irradiation treatment is not particularly limited and examples thereof include mercury lamp, metal halide lamp, xenon (Xe) lamp, chemical lamp, and carbon arc lamp. Examples of the radiation include electron rays, X-rays, ion beams and far infrared rays. In addition, g-line rays, i-line rays, deep UV rays, and high-density energy beams (laser beams) may also be used.

The pulsed light irradiation treatment is preferably performed with a flash lamp and more preferably with a xenon flash lamp.

The irradiation energy of the pulsed light is preferably 1 to 100 J/cm², more preferably 1 to 50 J/cm², and even more preferably 1 to 30 J/cm². The pulse width of the pulsed light is preferably 1 μs to 100 ms and more preferably 10 μs to 10 ms. The irradiation time of the pulsed light is preferably 1 μs to 1,000 ms, more preferably 1 ms to 500 ms, and even more preferably 1 ms to 200 ms.

The atmosphere under which the pulsed light irradiation treatment is performed is not particularly limited and examples thereof include an air atmosphere, an inert atmosphere and a reducing atmosphere. The inert atmosphere is an atmosphere filled with an inert gas such as argon, helium, neon or nitrogen, and the reducing atmosphere refers to an atmosphere containing a reducing gas such as hydrogen, carbon monoxide, formic acid or an alcohol.

(Conductive Film)

The copper-containing conductive film is obtained by performing this step.

The thickness of the conductive film is not particularly limited and is adjusted as appropriate according to the intended use to obtain an optimal film thickness. The conductive film preferably has a thickness of 0.01 to 1,000 μm and more preferably 0.1 to 100 μm particularly for use in a printed circuit board.

The conductive film may be provided over the entire surface of the substrate or in a pattern shape. The patterned conductive film is useful as conductor interconnects (interconnects) of a printed circuit board or the like.

Exemplary methods for obtaining the patterned conductive film includes a method which involves applying the conductive film-forming composition onto the substrate in a pattern shape and irradiating the applied composition with pulsed light and a method which involves etching the conductive film provided over the entire surface of the substrate in a pattern shape.

The etching method is not particularly limited and known techniques such as subtractive and semi-additive techniques may be employed.

In cases where the patterned conductive film is configured as a multilayer circuit board, an insulating layer (insulating resin layer, interlayer dielectric film, solder resist) may be further formed on the surface of the patterned conductive film and further interconnects (metal pattern) may be formed on the surface thereof.

The material of the insulating film is not particularly limited and examples thereof include epoxy resin, aramid resin, crystalline polyolefin resin, amorphous polyolefin resin, fluorine-containing resins (e.g., polytetrafluoroethylene, perfluorinated polyimide and perfluorinated amorphous resin), polyimide resin, polyethersulfone resin, polyphenylene sulfide resin, polyether ether ketone resin and liquid crystal resin.

Among these, the insulating film preferably contains epoxy resin, polyimide resin or liquid crystal resin and more preferably epoxy resin in terms of adhesion, dimension stability, heat resistance and electrical insulating properties. One specific example is ABF-GX13 manufactured by Ajinomoto Fine-Techno Co., Inc.

The solder resist which is a material of the insulating layer used for protecting interconnects is described in, for example, JP 10-204150 A and JP 2003-222993 A in detail, and the materials of the solder resist stated therein are also applicable to the present invention as desired. The solder resist to be used may be a commercial product. Specific examples of the solder resist include PFR800 and PSR4000 (trade names) manufactured by Taiyo Ink Mfg. Co., Ltd. and SR7200G manufactured by Hitachi Chemical Co., Ltd.

The substrate having the thus obtained conductive film (conductive film-carrying substrate) can be used in various applications, as exemplified by a printed circuit board, a TFT, an FPC and an RFID.

### EXAMPLES

The invention is described below in further detail by way of examples. However, the invention should not be construed as being limited to the following examples.

(Preparation of Composition 1)

Copper oxide particles (NanoTek CuO manufactured by C.I. Kasei Co., Ltd.; average particle size: 50 nm) (50 parts by weight), copper particles (MD-200 manufactured by Ishihara Sangyo Kaisha, Ltd.; gelatin polymer-coated copper particles; average particle size: 200 nm) (5 parts by weight), polyvinylpyrrolidone (weight-average molecular weight: 220,000) (10 parts by weight) as an organic polymer, water (20 parts by weight) and glycerol (15 parts by weight) were mixed and the mixture was treated for 5 minutes in a planetary centrifugal mixer (THINKY MIXER ARE-310 manufactured by Thinky Corporation) to obtain a conductive film-forming composition. The resulting conductive film-forming composition is called Composition 1.

(Preparation of Composition 2)

Copper oxide particles (NanoTek CuO manufactured by C.I. Kasei Co., Ltd.; average particle size: 50 nm) (50 parts by weight), copper particles (MD-200 manufactured by Ishihara Sangyo Kaisha, Ltd.; gelatin polymer-coated copper particles; average particle size: 200 nm) (10 parts by weight), polyvinylpyrrolidone (weight-average molecular weight: 220,000) (10 parts by weight) as an organic polymer, water (15 parts by weight) and glycerol (15 parts by weight) were mixed and the mixture was treated for 5 minutes in a planetary centrifugal mixer (THINKY MIXER ARE-310 manufactured by Thinky Corporation) to obtain a conductive film-forming composition. The resulting conductive film-forming composition is called Composition 2.

(Preparation of Composition 3)

The same procedure as for Composition 1 was repeated except that copper oxide particles (NanoTek CuO manufactured by C.I. Kasei Co., Ltd.; average particle size: 50 nm) (40 parts by weight) were mixed in place of the copper oxide particles (NanoTek CuO manufactured by C.I. Kasei Co., Ltd.; average particle size: 50 nm) (50 parts by weight), copper particles (MD-200 manufactured by Ishihara Sangyo Kaisha, Ltd.; gelatin polymer-coated copper particles; average particle size: 200 nm) (20 parts by weight) were mixed in place of the copper particles (MD-200 manufactured by Ishihara Sangyo Kaisha, Ltd.; gelatin polymer-coated copper particles; average particle size: 200 nm) (5 parts by weight), and water (15 parts by weight) was mixed in place of the water (20 parts by weight), thereby obtaining a conductive film-forming composition. The resulting conductive film-forming composition is called Composition 3.

(Preparation of Composition 4)

The same procedure as for Composition 1 was repeated except that copper oxide particles (NanoTek CuO manufactured by C.I. Kasei Co., Ltd.; average particle size: 50 nm) (40 parts by weight) were mixed in place of the copper oxide particles (NanoTek CuO manufactured by C.I. Kasei Co., Ltd.; average particle size: 50 nm) (50 parts by weight), copper particles (MD-200 manufactured by Ishihara Sangyo Kaisha, Ltd.; gelatin polymer-coated copper particles; average particle size: 200 nm) (10 parts by weight) were mixed in place of the copper particles (MD-200 manufactured by Ishihara Sangyo Kaisha, Ltd.; gelatin polymer-coated copper particles; average particle size: 200 nm) (5 parts by weight), and water (25 parts by weight) was mixed in place of the water (20 parts by weight), thereby obtaining a conductive film-forming composition. The resulting conductive film-forming composition is called Composition 4.

(Preparation of Composition 5)

The same procedure as for Composition 2 was repeated except that copper particles (Mitsui Mining & Smelting Co., Ltd.; average particle size: 370 nm) (10 parts by weight) were mixed in place of the copper particles (MD-200 manufactured by Ishihara Sangyo Kaisha, Ltd.; gelatin polymer-coated copper particles; average particle size: 200 nm) (10 parts by weight), thereby obtaining a conductive film-forming composition. The resulting conductive film-forming composition is called Composition 5.

(Preparation of Composition 6)

The same procedure as for Composition 2 was repeated except that copper particles (MD-50 manufactured by Ishihara Sangyo Kaisha, Ltd.; gelatin polymer-coated copper particles; average particle size: 50 nm) (10 parts by weight) were mixed in place of the copper particles (MD-200 manufactured by Ishihara Sangyo Kaisha, Ltd.; gelatin polymer-coated copper particles; average particle size: 200 nm) (10 parts by weight), thereby obtaining a conductive film-forming composition. The resulting conductive film-forming composition is called Composition 6.

(Preparation of Composition 7)

The same procedure as for Composition 2 was repeated except that polyvinylpyrrolidone (weight-average molecular weight: 40,000) (10 parts by weight) was mixed in place of the polyvinylpyrrolidone (weight-average molecular weight: 220,000) (10 parts by weight), thereby obtaining a conductive film-forming composition. The resulting conductive film-forming composition is called Composition 7.

(Preparation of Composition 8)

The same procedure as for Composition 2 was repeated except that copper oxide particles (NanoTek CuO manufactured by C.I. Kasei Co., Ltd.; average particle size: 50 nm) (44 parts by weight) were mixed in place of the copper oxide particles (NanoTek CuO manufactured by C.I. Kasei Co., Ltd.; average particle size: 50 nm) (50 parts by weight), copper particles (MD-200 manufactured by Ishihara Sangyo Kaisha, Ltd.; gelatin polymer-coated copper particles; average particle size: 200 nm) (22 parts by weight) were mixed in place of the copper particles (MD-200 manufactured by Ishihara Sangyo Kaisha, Ltd.; gelatin polymer-coated copper particles; average particle size: 200 nm) (10 parts by weight), and water (9 parts by weight) was mixed in place of the water (15 parts by weight), thereby obtaining a conductive film-forming composition. The resulting conductive film-forming composition is called Composition 8.

(Preparation of Composition 9)

The same procedure as for Composition 2 was repeated except that polyvinylpyrrolidone (weight-average molecular weight: 220,000) (4 parts by weight) was mixed in place of the polyvinylpyrrolidone (weight-average molecular weight: 220,000) (10 parts by weight) and water (21 parts by weight) was mixed in place of the water (15 parts by weight), thereby obtaining a conductive film-forming composition. The resulting conductive film-forming composition is called Composition 9.

(Preparation of Composition 10)

The same procedure as for Composition 2 was repeated except that polyvinylpyrrolidone (weight-average molecular weight: 220,000) (17 parts by weight) was mixed in place of the polyvinylpyrrolidone (weight-average molecular weight: 220,000) (10 parts by weight) and water (8 parts by weight) was mixed in place of the water (15 parts by weight), thereby obtaining a conductive film-forming composition. The resulting conductive film-forming composition is called Composition 10.

(Preparation of Composition 11)

The same procedure as for Composition 2 was repeated except that polyvinylpyrrolidone (weight-average molecular weight: 360,000) (10 parts by weight) was mixed in place of the polyvinylpyrrolidone (weight-average molecular weight: 220,000) (10 parts by weight), thereby obtaining a conductive film-forming composition. The resulting conductive film-forming composition is called Composition 11.

(Preparation of Composition 12)

The same procedure as for Composition 2 was repeated except that copper particles (Cu-HWQ manufactured by Fukuda Metal Foil & Powder Co., Ltd.; average particle size: 3,000 nm) (10 parts by weight) were mixed in place of the copper particles (MD-200 manufactured by Ishihara Sangyo Kaisha, Ltd.; gelatin polymer-coated copper particles; average particle size: 200 nm) (10 parts by weight), thereby obtaining a conductive film-forming composition. The resulting conductive film-forming composition is called Composition 12.

(Preparation of Composition 13)

The same procedure as for Composition 2 was repeated except that copper particles (MD-200 manufactured by Ishihara Sangyo Kaisha, Ltd.; gelatin polymer-coated copper particles; average particle size: 200 nm) (8 parts by weight) were mixed in place of the copper particles (MD-200 manufactured by Ishihara Sangyo Kaisha, Ltd.; gelatin polymer-coated copper particles; average particle size: 200 nm) (10 parts by weight) and water (17 parts by weight) was mixed in place of the water (15 parts by weight), thereby obtaining a conductive film-forming composition. The resulting conductive film-forming composition is called Composition 13.

(Preparation of Comparative Composition 1)

The same procedure as for Composition 2 was repeated except that copper particles were not mixed and water (25 parts by weight) was mixed in place of the water (15 parts by weight), thereby obtaining a conductive film-forming composition. The resulting conductive film-forming composition is called Comparative Composition 1.

(Preparation of Comparative Composition 2)

The same procedure as for Composition 2 was repeated except that copper particles (MD-200 manufactured by Ishihara Sangyo Kaisha, Ltd.; gelatin polymer-coated copper particles; average particle size: 200 nm) (1 part by weight) were mixed in place of the copper particles (MD-200 manufactured by Ishihara Sangyo Kaisha, Ltd.; gelatin polymer-coated copper particles; average particle size: 200 nm) (10 parts by weight) and water (24 parts by weight) was mixed in place of the water (15 parts by weight), thereby obtaining a conductive film-forming composition. The resulting conductive film-forming composition is called Comparative Composition 2.

(Preparation of Comparative Composition 3)

The same procedure as for Composition 2 was repeated except that copper oxide particles (NanoTek CuO manufactured by C.I. Kasei Co., Ltd.; average particle size: 50 nm) (40 parts by weight) were mixed in place of the copper oxide particles (NanoTek CuO manufactured by C.I. Kasei Co., Ltd.; average particle size: 50 nm) (50 parts by weight), copper particles (MD-200 manufactured by Ishihara Sangyo Kaisha, Ltd.; gelatin polymer-coated copper particles; average particle size: 200 nm) (25 parts by weight) were mixed in place of the copper particles (MD-200 manufactured by Ishihara Sangyo Kaisha, Ltd.; gelatin polymer-coated copper particles; average particle size: 200 nm) (10 parts by weight), and water (10 parts by weight) was mixed in place of the water (15 parts by weight), thereby obtaining a conductive film-forming composition. The resulting conductive film-forming composition is called Comparative Composition 3.

(Preparation of Comparative Composition 4)

The same procedure as for Composition 2 was repeated except that copper oxide particles (NanoTek CuO manufactured by C.I. Kasei Co., Ltd.; average particle size: 50 nm) (10 parts by weight) were mixed in place of the copper oxide particles (NanoTek CuO manufactured by C.I. Kasei Co., Ltd.; average particle size: 50 nm) (50 parts by weight), copper particles (MD-200 manufactured by Ishihara Sangyo Kaisha, Ltd.; gelatin polymer-coated copper particles; average particle size: 200 nm) (50 parts by weight) were mixed in place of the copper particles (MD-200 manufactured by Ishihara Sangyo Kaisha, Ltd.; gelatin polymer-coated copper particles; average particle size: 200 nm) (10 parts by weight), thereby obtaining a conductive film-forming composition. The resulting conductive film-forming composition is called Comparative Composition 4.

(Preparation of Comparative Composition 5)

The same procedure as for Composition 2 was repeated except that copper particles (MD-200 manufactured by Ishihara Sangyo Kaisha, Ltd.; gelatin polymer-coated copper particles; average particle size: 200 nm) (4.5 parts by weight) were mixed in place of the copper particles (MD-200 manufactured by Ishihara Sangyo Kaisha, Ltd.; gelatin polymer-coated copper particles; average particle size: 200 nm) (10 parts by weight) and water (20.5 parts by weight) was mixed in place of the water (15 parts by weight), thereby obtaining a conductive film-forming composition. The resulting conductive film-forming composition is called Comparative Composition 5.

### Example 1

Composition 1 was applied in a stripe shape (L/S=1 mm/1 mm) onto a PET substrate (OHP film for PPC and laser applications; GAAA5224 manufactured by Fuji Xerox Co., Ltd.; thickness: 50 μm; Tg: 69° C.) using a screen printer and then dried at 100° C. for 10 minutes to obtain a coating. The resulting coating was irradiated with pulsed light (photonic sintering system Sinteron 2000 manufactured by Xenon Corporation; irradiation energy: 5 J/cm²; pulse width: 2 ms) to obtain a conductive film.

### Example 2

The same procedure as in Example 1 was repeated except that Composition 1 was replaced by Composition 2, thereby obtaining a conductive film.

### Example 3

The same procedure as in Example 1 was repeated except that Composition 1 was replaced by Composition 3, thereby obtaining a conductive film.

### Example 4

The same procedure as in Example 1 was repeated except that Composition 1 was replaced by Composition 4, thereby obtaining a conductive film.

### Example 5

The same procedure as in Example 1 was repeated except that Composition 1 was replaced by Composition 5, thereby obtaining a conductive film.

### Example 6

The same procedure as in Example 1 was repeated except that Composition 1 was replaced by Composition 6, thereby obtaining a conductive film.

### Example 7

The same procedure as in Example 1 was repeated except that Composition 1 was replaced by Composition 7, thereby obtaining a conductive film.

### Example 8

The same procedure as in Example 1 was repeated except that the PET substrate was replaced by a polycarbonate (PC) substrate (Panlite PC-2151 manufactured by Teijin Limited; thickness: 125 μm; Tg: 150° C.), thereby obtaining a conductive film.

### Example 9

The same procedure as in Example 1 was repeated except that the PET substrate was replaced by a PEN substrate (Teonex Q51 manufactured by Teijin Limited; thickness: 125 μm; Tg: 155° C.), thereby obtaining a conductive film.

### Example 10

The same procedure as in Example 1 was repeated except that the PET substrate was replaced by a polyimide (PI) substrate (Kapton 500H manufactured by Du Pont-Toray Co., Ltd.; thickness: 125 μm; Tg: more than 300° C.), thereby obtaining a conductive film.

### Example 11

The same procedure as in Example 1 was repeated except that Composition 1 was replaced by Composition 8, thereby obtaining a conductive film.

### Example 12

The same procedure as in Example 1 was repeated except that Composition 1 was replaced by Composition 9, thereby obtaining a conductive film.

### Example 13

The same procedure as in Example 1 was repeated except that Composition 1 was replaced by Composition 10, thereby obtaining a conductive film.

### Example 14

The same procedure as in Example 1 was repeated except that Composition 1 was replaced by Composition 11, thereby obtaining a conductive film.

### Example 15

The same procedure as in Example 1 was repeated except that Composition 1 was replaced by Composition 12, thereby obtaining a conductive film.

### Example 16

The same procedure as in Example 1 was repeated except that Composition 1 was replaced by Composition 13, thereby obtaining a conductive film.

### Comparative Example 1

The same procedure as in Example 1 was repeated except that Composition 1 was replaced by Comparative Composition 1, thereby obtaining a conductive film.

### Comparative Example 2

The same procedure as in Example 1 was repeated except that Composition 1 was replaced by Comparative Composition 2, thereby obtaining a conductive film.

### Comparative Example 3

The same procedure as in Example 1 was repeated except that Composition 1 was replaced by Comparative Composition 3, thereby obtaining a conductive film.

### Comparative Example 4

An attempt was made to obtain a conductive film according to the same procedure as in Example 1 except that Composition 1 was replaced by Comparative Composition 4. However, the composition scattered and no conductive film was obtained, so that the adhesion and the electrical conductivity to be described later could not be evaluated.

### Comparative Example 5

The same procedure as in Example 1 was repeated except that the PET substrate was replaced by a glass substrate (glass slide S1214 manufactured by Matsunami Glass Ind., Ltd.; thickness: 1,300 μm), thereby obtaining a conductive film.

### Comparative Example 6

The same procedure as in Example 1 was repeated except that Composition 1 was replaced by Comparative Composition 5, thereby obtaining a conductive film.

<Adhesion>

A cellophane tape (width: 24 mm) available from Nichiban Co., Ltd. was firmly attached to each of the resulting conductive films and then peeled off. The appearance of each conductive film after having been peeled off was visually observed to evaluate the adhesion. Evaluation criteria are as follows: From a practical point of view, A to C are preferable, A or B is more preferable, and A is even more preferable.
A: Neither adhesion of the conductive film to the tape nor interfacial delamination between the conductive film and the substrate is seen.
B: The conductive film slightly adheres to the tape but interfacial delamination between the conductive film and the substrate is not seen.
C: The conductive film noticeably adheres to the tape and interfacial delamination between the conductive film and the substrate is slightly seen.
D: The conductive film noticeably adheres to the tape and interfacial delamination between the conductive film and the substrate is clearly seen.

<Electrical Conductivity>

A four point probe resistivity meter was used to measure the volume resistivity of the resulting conductive films, thereby evaluating the electrical conductivity. Evaluation criteria are as follows:
A: The volume resistivity is less than 50 μΩ·cm.
B: The volume resistivity is 50 μΩ·cm or more but less than 100 μΩ·cm.
C: The volume resistivity is 100 μΩ·cm or more.

The contents in Table 1 are expressed by the ratio (wt %) of the amount of each ingredient to the total amount of the conductive film-forming composition.

TABLE 1

| | | | Conductive film-forming composition | | | | | | | | | | | | |
|---|---|---|---|---|---|---|---|---|---|---|---|---|---|---|---|
| | | | | Copper | | | | | | | | | | | |
| | | | | oxide | | Copper | | | | | | | | | |
| | | | | particles (A) | | particles (B) | | | | | | | | | Elec- |
| | | | | | Average | | Average | Organic | | | | | | | trical |
| | Substrate | | Com- | | particle | | particle | polymer (C) | | | | Water | Glycerol | | con- |
| | | Tg | position | Content | size | Content | size | B/A | Content | | C/A | Content | Content | Ad- | duc- |
| | Type | (° C.) | No. | (wt %) | (nm) | (wt %) | (nm) | (wt %) | (wt %) | Mw | (wt %) | (wt %) | (wt %) | hesion | tivity |
| EX 1 | PET | 69 | Com- | 50 | 50 | 5 | 200 | 10 | 10 | 220000 | 20 | 20 | 15 | B | A |
| | | | position 1 | | | | | | | | | | | | |
| EX 2 | PET | 69 | Com- | 50 | 50 | 10 | 200 | 20 | 10 | 220000 | 20 | 15 | 15 | A | A |
| | | | position 2 | | | | | | | | | | | | |
| EX 3 | PET | 69 | Com- | 40 | 50 | 20 | 200 | 50 | 10 | 220000 | 25 | 15 | 15 | A | A |
| | | | position 3 | | | | | | | | | | | | |
| EX 4 | PET | 69 | Com- | 40 | 50 | 10 | 200 | 25 | 10 | 220000 | 25 | 25 | 15 | A | A |
| | | | position 4 | | | | | | | | | | | | |
| EX 5 | PET | 69 | Com- | 50 | 50 | 10 | 370 | 20 | 10 | 220000 | 20 | 15 | 15 | B | B |
| | | | position 5 | | | | | | | | | | | | |
| EX 6 | PET | 69 | Com- | 50 | 50 | 10 | 50 | 20 | 10 | 220000 | 20 | 15 | 15 | B | A |
| | | | position 6 | | | | | | | | | | | | |
| EX 7 | PET | 69 | Com- | 50 | 50 | 10 | 200 | 20 | 10 | 40000 | 20 | 15 | 15 | B | C |
| | | | position 7 | | | | | | | | | | | | |
| EX 8 | PC | 150 | Com- | 50 | 50 | 10 | 200 | 20 | 10 | 220000 | 20 | 15 | 15 | A | A |
| | | | position 1 | | | | | | | | | | | | |
| EX 9 | PEN | 155 | Com- | 50 | 50 | 10 | 200 | 20 | 10 | 220000 | 20 | 15 | 15 | A | A |
| | | | position 1 | | | | | | | | | | | | |
| EX 10 | PI | >300 | Com- | 50 | 50 | 10 | 200 | 20 | 10 | 220000 | 20 | 15 | 15 | B | B |
| | | | position 1 | | | | | | | | | | | | |
| EX 11 | PET | 69 | Com- | 44 | 50 | 22 | 200 | 50 | 10 | 220000 | 23 | 9 | 15 | B | A |
| | | | position 8 | | | | | | | | | | | | |
| EX 12 | PET | 69 | Com- | 50 | 50 | 10 | 200 | 20 | 4 | 220000 | 8 | 21 | 15 | A | B |
| | | | position 9 | | | | | | | | | | | | |
| EX 13 | PET | 69 | Com- | 50 | 50 | 10 | 200 | 20 | 17 | 220000 | 34 | 8 | 15 | A | B |
| | | | position | | | | | | | | | | | | |
| | | | 10 | | | | | | | | | | | | |
| EX 14 | PET | 69 | Com- | 50 | 50 | 10 | 200 | 20 | 10 | 360000 | 20 | 15 | 15 | A | C |
| | | | position | | | | | | | | | | | | |
| | | | 11 | | | | | | | | | | | | |
| EX 15 | PET | 69 | Com- | 50 | 50 | 10 | 3000 | 20 | 10 | 220000 | 20 | 15 | 15 | C | C |
| | | | position | | | | | | | | | | | | |
| | | | 12 | | | | | | | | | | | | |
| EX 16 | PET | 69 | Com- | 50 | 50 | 8 | 200 | 16 | 10 | 220000 | 20 | 17 | 15 | A | A |
| | | | position | | | | | | | | | | | | |
| | | | 13 | | | | | | | | | | | | |
| CE 1 | PET | 69 | Com- | 50 | 50 | 0 | 200 | 0 | 10 | 220000 | 20 | 25 | 15 | D | C |
| | | | parative | | | | | | | | | | | | |
| | | | Com- | | | | | | | | | | | | |
| | | | position 1 | | | | | | | | | | | | |
| CE 2 | PET | 69 | Com- | 50 | 50 | 1 | 200 | 2 | 10 | 220000 | 20 | 24 | 15 | D | C |
| | | | parative | | | | | | | | | | | | |
| | | | Com- | | | | | | | | | | | | |
| | | | position 2 | | | | | | | | | | | | |
| CE 3 | PET | 69 | Com- | 40 | 50 | 25 | 200 | 63 | 10 | 220000 | 25 | 10 | 15 | D | C |
| | | | parative | | | | | | | | | | | | |
| | | | Com- | | | | | | | | | | | | |
| | | | position 3 | | | | | | | | | | | | |
| CE 4 | PET | 69 | Com- | 10 | 50 | 50 | 200 | 500 | 10 | 220000 | 100 | 15 | 15 | Un- | Un- |
| | | | parative | | | | | | | | | | | eval- | eval- |
| | | | Com- | | | | | | | | | | | uable | uable |
| | | | position 4 | | | | | | | | | | | | |
| CE 5 | Glass | — | Com- | 50 | 50 | 10 | 200 | 20 | 10 | 220000 | 20 | 15 | 15 | D | B |
| | | | position 1 | | | | | | | | | | | | |
| CE 6 | PET | 69 | Com- | 50 | 50 | 4.5 | 200 | 9 | 10 | 220000 | 20 | 20.5 | 15 | D | B |
| | | | parative | | | | | | | | | | | | |
| | | | Com- | | | | | | | | | | | | |
| | | | position 5 | | | | | | | | | | | | |

As is seen from Table 1, the conductive film obtained by the method in Comparative Example 1 in which no copper particles (B) were contained and the conductive films obtained by the methods in Comparative Examples 2 and 6 in which the ratio of the copper particle (B) content to the copper oxide particle (A) content as expressed by B/A was less than 10 wt % had insufficient adhesion to their corresponding substrates. The conductive film obtained by the method in Comparative Example 3 in which B/A exceeded 50 wt % also had insufficient adhesion to its corresponding substrate. In Comparative Example 4 in which the copper particle (B) content was considerably higher than the copper oxide particle (A) content, the composition scattered and no conductive film was obtained, as already described above.

The conductive film obtained by the method in Comparative Example 5 in which B/A was within the predetermined range but the substrate used was not a thermoplastic resin substrate but a glass substrate also had insufficient adhesion to its corresponding substrate.

On the other hand, each of the conductive films obtained by the methods in Examples in which each substrate used was a thermoplastic resin substrate and B/A was within the predetermined range had sufficient adhesion to its corresponding substrate.

As is seen from the comparison of Examples 1 to 4, 11 and 16, the conductive films obtained by the methods in Examples 2 to 4 and 16 in which the copper particles were contained in an amount of 7 to 20 wt % with respect to the total amount of the conductive film-forming composition had better adhesion to their corresponding substrates than the conductive film obtained by the method in Example 1 in which the copper particles were contained in an amount of less than 7 wt % with respect to the total amount of the conductive film-forming composition and the conductive film obtained by the method in Example 11 in which the copper particles were contained in an amount exceeding 20 wt % with respect to the total amount of the conductive film-forming composition.

As is seen from the comparison of Examples 1 to 4, 11 to 13 and 16, the conductive films obtained by the methods in Examples 1 to 4, 11 and 16 in which the ratio of the organic polymer (C) content to the copper oxide particle (A) content as expressed by C/A was in a range of 10 to 30 wt % had better electrical conductivity than the conductive film obtained by the method in Example 12 in which C/A was less than 10 wt % and the conductive film obtained by the method in Example 13 in which C/A exceeded 30 wt %.

As is seen from the comparison of Examples 2, 7 and 14, the conductive films obtained by the methods in Examples 2 and 14 in which the weight-average molecular weight of the organic polymer (C) was not less than 100,000 had better adhesion to their corresponding substrates than the conductive film obtained by the method in Example 7 in which the weight-average molecular weight of the organic polymer (C) was less than 100,000. In particular, the conductive film obtained by the method in Example 2 in which the weight-average molecular weight of the organic polymer (C) was up to 300,000 had better electrical conductivity.

As is seen from the comparison of Examples 2, 5, 6 and 15, the conductive films obtained by the methods in Examples 2, 5 and 6 in which the average particle size of the copper particles (B) was up to 500 nm had better adhesion to their corresponding substrates than the conductive film obtained by the method in Example 15 in which the average particle size of the copper particles (B) exceeded 500 nm. In particular, the conductive films obtained by the methods in Examples 2 and 6 in which the average particle size of the copper particles (B) was up to 250 nm had better electrical conductivity than the conductive film obtained by the method in Example 5 in which the average particle size of the copper particles (B) exceeded 250 nm. In particular, the conductive film obtained by the method in Example 2 in which the average particle size of the copper particles (B) was not less than 100 nm had even better adhesion to its corresponding substrate than the conductive film obtained by the method in Example 6 in which the average particle size of the copper particles (B) was less than 100 nm.

What is claimed is:

1. A conductive film manufacturing method comprising:
a coating formation step of forming a coating by applying onto a thermoplastic resin substrate a conductive film-forming composition comprising copper oxide particles (A); copper particles (B); and an organic polymer (C), a ratio of a copper particle (B) content to a copper oxide particle (A) content as expressed by B/A being 10 to 50 wt %; and
a reduction step of reducing the copper oxide particles (A) through irradiation of the coating with pulsed light, thereby forming a copper-containing conductive film.

2. The conductive film manufacturing method according to claim 1, wherein the ratio as expressed by B/A is 15 to 40 wt %.

3. The conductive film manufacturing method according to claim 1, wherein the copper particles (B) are contained in an amount of 10 to 20 wt % with respect to a total amount of the conductive film-forming composition.

4. The conductive film manufacturing method according to claim 1, wherein the copper oxide particles (A) are contained in an amount of 40 to 60 wt % with respect to a total amount of the conductive film-forming composition.

5. The conductive film manufacturing method according to claim 1, wherein a ratio of an organic polymer (C) content to the copper oxide particle (A) content as expressed by C/A is 10 to 30 wt %.

6. The conductive film manufacturing method according to claim 1, wherein the copper particles (B) have an average particle size of 50 to 500 nm.

7. The conductive film manufacturing method according to claim 1, wherein the organic polymer (C) has a weight-average molecular weight of 100,000 or more.

8. The conductive film manufacturing method according to claim 1, wherein a thermoplastic resin making up the thermoplastic resin substrate has a glass transition temperature of 160° C. or less.

9. The conductive film manufacturing method according to claim 1, wherein the organic polymer (C) is at least one polymer selected from the group consisting of polyvinylpyrrolidone, polyvinyl alcohol and polyethylene glycol.

10. The conductive film manufacturing method according to claim 1, wherein the copper oxide particles (A) are copper(II) oxide particles.

11. The conductive film manufacturing method according to claim 1, wherein the conductive film-forming composition further comprises water or a water-soluble alcohol as a main solvent.

12. The conductive film manufacturing method according to claim 1, wherein the thermoplastic resin substrate is a polyethylene terephthalate substrate.

13. The conductive film manufacturing method according to claim 1, wherein the copper particles (B) are polymer-coated copper particles.

14. The conductive film manufacturing method according to claim 1, further comprising a drying step of drying the coating prior to the reduction step.

15. The conductive film manufacturing method according to claim 2, wherein the copper particles (B) are contained in an amount of 10 to 20 wt % with respect to a total amount of the conductive film-forming composition.

16. The conductive film manufacturing method according to claim 2, wherein the copper oxide particles (A) are contained in an amount of 40 to 60 wt % with respect to a total amount of the conductive film-forming composition.

17. The conductive film manufacturing method according to claim 2, wherein a ratio of an organic polymer (C) content to the copper oxide particle (A) content as expressed by C/A is 10 to 30 wt %.

18. The conductive film manufacturing method according to claim 2, wherein the copper particles (B) have an average particle size of 50 to 500 nm.

19. A conductive film-forming composition comprising: copper oxide particles (A); copper particles (B); and an organic polymer (C), wherein a ratio of a copper particle (B) content to a copper oxide particle (A) content as expressed by B/A is 10 to 50 wt %.

20. The conductive film-forming composition according to claim 19, wherein the ratio as expressed by B/A is 15 to 40 wt %.
